(19) United States
(12) Patent Application Publication
(10) Pub. No.: US 2019/0252665 A1
(43) Pub. Date: Aug. 15, 2019

(54) ENHANCED FLOODED BATTERY SEPARATORS, METHOD OF MANUFACTURE AND METHOD OF USE

(71) Applicant: MICROPOROUS, LLC, Piney Flats, TN (US)

(72) Inventor: Jeffrey K. CHAMBERS, Piney Flats, TN (US)

(21) Appl. No.: 16/272,846

(22) Filed: Feb. 11, 2019

Related U.S. Application Data
(60) Provisional application No. 62/629,656, filed on Feb. 12, 2018.

(51) Int. Cl. H01M 2/16; H01M 2/14; H01M 10/12; H01M 10/08

(52) U.S. Cl. CPC H01M 2/1673; H01M 2/145; H01M 10/08; H01M 10/121; H01M 2/162

(57) ABSTRACT

A method of battery separator manufacture and method of use whereby an additive is deployed to mitigate the destructive process of volumetric depletion of electrolyte in a lead-acid battery (known as “water loss”). A set of techniques is disclosed herein for the application of chemically specific additives to address the deleterious effect to critical battery performance features brought about by the sustained reduction in battery electrolyte volume (“water loss”) over the battery service life.

### CROSS-REFERENCE TO RELATED APPLICATIONS

This application claims benefit of priority application, U.S. Provisional Ser. No. 62/629,656 filed Feb. 12, 2018 entitled “Enhanced Flooded Battery Separators, Method of Manufacture and Method of Use”, which is incorporated herein by reference in its entirety.

### FIELD OF THE DISCLOSURE

The present disclosure is directed to battery separators, components, lead-acid batteries, systems, and/or related methods of production and/or use thereof, including additives for use with a battery separator for use in a lead-acid battery. In at least select embodiments, the instant disclosure relates to new or improved lead-acid battery separators and/or systems including improved water loss technology and/or methods of manufacture and/or use thereof. In at least select embodiments, the instant disclosure is directed toward a new or improved lead-acid battery separator or system with one additive, or a mixture of additives, and/or methods for constructing lead-acid battery separators and batteries with such additives for improving and/or reducing water loss from the battery.

### BACKGROUND

Generally speaking, lead-acid batteries have evolved, over time, as the demands for a source of mobile electric power have grown. There are two main types of lead-acid batteries: flooded lead-acid batteries and VRLA (Valve Regulated Lead-acid) batteries. The instant disclosure may be particularly useful for flooded lead-acid batteries which are commonly used all over the world. A newer type of flooded lead-acid battery is an EFB battery, or an enhanced flooded battery. For example, the new, ever growing requirements for “Idle-Stop-Start” automobile technology places an emphasis on more stringent performance parameters for lead-acid batteries and therefore a more robust battery, the “enhanced” flooded battery, or EFB is in widespread development. EFB battery technology differs from conventional lead-acid battery technology in many ways and these differences may further vary from one manufacturer to another. An example of one of the differences between EFB battery technology and conventional battery technology is the ever-growing trend to introduce high surface carbon compounds within the material comprising the electrode active materials. This attribute, among other attributes found specifically in EFB batteries, has resulted in the need for a means to control the loss of battery electrolyte over the service life of the battery.

The gradual reduction in electrolyte volume within the battery over service life is known to those skilled in the art as “water loss”. Water loss in lead-acid batteries is a known problem and may occur for many different reasons. For example, water loss may occur in lead-acid batteries as the overvoltage of hydrogen is exceeded. This may be typical and occur to some extent as the electrochemical mechanism dictates. The effects of water loss may be greatly amplified in climates with sustained high temperature. Water loss has been identified as a major contributor to the following critical failure modes in lead-acid batteries: electrode plate dehydration, which may lead to battery failure; dry-out in a sealed VRLA battery, which may lead to potentially dangerous thermal runaway; negative plate sulfation, which may lead to reduced charge acceptance and/or reduced cycle life; and/or increased specific gravity of electrolyte, which may lead to negative plate sulfation and/or positive electrode “grid” corrosion.

The deleterious effects of the water loss phenomenon are evidenced by: a reduced level of electrolyte leading to dry-out, thus exposing battery component weld points, electrode plates and connections leading to accelerated corrosion and causing early battery failure; increasing electrolyte acid concentration, thus reducing energy storage capacity, negative plate sulfation and positive electrode grid corrosion leading to early failure; and/or outgassing of H2 and O2 gasses, possibly creating an exposure and handling hazard thus requiring venting. As such, reducing water loss in lead-acid batteries may help eliminate: plate dehydration leading to early capacity loss and shortened life; negative plate sulfation, reducing service life; and/or positive grid corrosion, reducing key performance features such as Cold Cranking Amperage (CCA), capacity and life. Water loss from lead-acid batteries may be mainly due to electrolysis and subsequent gassing of hydrogen and oxygen, which may be more apparent in high temperature climates or applications.

EFBs may suffer from any of these water loss scenarios, including evaporation and electrolysis of water. Water loss, whether through evaporation and/or electrolysis, is commonly known to lower the performance and/or life of the EFB. As such, many methods have been developed to combat this drawback, including VRLA/AGM type batteries. However, even in a sealed VRLA/AGM battery, for example, the potential for dry-out is present, and a potential thermal runaway could occur in the VRLA/AGM design arising from water loss. Thus, it can be said that various known and/or already developed methods of combating water loss in lead-acid batteries provide little reduction in water loss and may require high costs that may not match the value brought forth by various developed methods. As such, there is clearly a need to develop lead-acid batteries and systems with improved water loss performance, and/or the ability to reduce evaporation and/or electrolysis of water in a flooded lead-acid battery that is cost effective.

The battery separator of a flooded lead-acid battery is a component that divides or “separates” the positive electrode from the negative electrode within a lead-acid battery cell. A battery separator may have two primary functions. First, a battery separator should keep the positive electrode physically apart from the negative electrode in order to prevent any electronic current passing between the two electrodes. Second, a battery separator should permit an ionic current between the positive and negative electrodes with the least possible resistance. A battery separator can be made out of many different materials, but these two opposing functions have been met well by a battery separator being made of a porous nonconductor.

Various battery separators have been developed over time to try and combat water loss in a flooded lead-acid battery. By way of example only, U.S. Pat. Nos. 6,703,161 and 6,689,509 (both of which are incorporated by reference herein in their entireties) mention combatting water loss by using a battery separator of a larger pore size. Additionally, U.S. Patent Publication No. 2014/0255752, which is incorporated by reference herein in its entirety, describes using a diffusive mat to protect against water loss in a battery, while other ways to approach water loss reduction in batteries are described in U.S. Patent Publication Nos. 2012/0070747 and 2012/0070713 (both of which are incorporated by reference herein in their entireties).

Other battery separators have been developed to help improve the performance and/or life of the battery. One such disclosure includes the separators that contain one or more additives as disclosed in U.S. Patent Publication No. 2012/0094183, which is incorporated by reference herein in its entirety. The separators with the additives (additives such as alkoxylated alcohol additives) described by that patent publication help to reduce water loss in a flooded lead-acid battery. Further reduction in water loss in a flooded lead-acid battery is even more desirable. Hence the present disclosure seeks to further improve the water loss reduction for a flooded lead-acid battery.

Non-separator based practices have been proposed whereby the battery electrolyte is “doped” with a viscous oil which is insoluble in the battery electrolyte. The oil phase separates from the aqueous electrolyte thus forming a physical “barrier” to Hydrogen evolution when overvoltage is reached. This technique has found limited commercial utility as each battery manufactured requires a separate filling step and the practice is limited to addressing water loss in a symptomatic rather than root cause manner. One such example of this approach is disclosed in Lajeunesse, U.S. Pat. No. 5,962,164 which is incorporated herein in its entirety.

Therefore, a need clearly exists for new developments for reducing water loss in lead-acid batteries that are cost effective. The instant disclosure may be designed to address at least certain aspects of the problems or needs discussed above by providing new and/or improved additives for use with battery separators for use in flooded lead-acid batteries, such that the resulting lead-acid batteries or systems exhibit improved water loss, or reduced water loss, compared with known lead-acid batteries or systems.

### SUMMARY

In accordance with at least selected embodiments, the instant disclosure may address at least certain aspects of the above mentioned needs, issues and/or problems and may provide new or improved battery separators for lead-acid batteries. In general, the instant disclosure may provide new or improved lead-acid battery separators and/or methods of manufacture and/or use thereof. In at least select embodiments, the instant disclosure may provide one or more additives for a battery separator and/or for a lead-acid battery system, as well as methods for constructing lead-acid battery separators and/or battery systems including such additives for improving and/or reducing water loss for a lead-acid battery. In one embodiment, a method of improving and/or reducing water loss of a lead-acid battery may include providing a separator as well as an additive where the additive component may improve and/or reduce water loss for the system.

Briefly described, in an example embodiment, the present disclosure overcomes the above-mentioned disadvantages and meets the recognized need for enhanced flooded batteries and separators thereof, and methods of manufacture and use thereof.

According to one aspect, the instant disclosure may be directed toward a lead-acid battery. The lead-acid battery may generally include an additive deployed in the lead-acid battery configured to mitigate water loss and destructive processes within the lead-acid battery as a result of the water loss. The additive may be deployed in the lead-acid battery to address deleterious effects to critical battery performance features brought about by a sustained reduction in battery electrolyte volume over a service life of the lead-acid battery. As examples, and clearly not limited thereto, the additive deployed in the lead-acid battery may be configured to suppress a rate of water loss over a service life of the lead-acid battery resulting in a reduced level of electrolyte leading to dry-out, thus exposing battery component weld points, electrode plates and connections leading to accelerated corrosion, increasing an electrolyte acid concentration, a negative electrode sulfation and a positive electrode grid corrosion and an excessive outgassing of H2 and O2 gasses. As a result, the consequences of water loss may affect key battery performance features including an energy storage capacity, a cold cranking amperage, a hazardous gas venting, and a marked reduction in cycling or service life.

In select embodiments of the lead-acid battery of the instant disclosure, the additive deployed in the lead-acid battery may have a general formula of: C(X) H(Y) O (Z). In select embodiments of this general formula of C(X) H(Y) O (Z) for the additive, the X may be 8 to 18 carbon atoms, the Y may be 1 to 38 hydrogen atoms, and the Z may be 0 to 1 oxygen atoms. In other select embodiments of this general formula of C(X) H(Y) O (Z) for the additive, the X may be 12 to 16 carbon atoms, the Y may be 26 to 34 hydrogen atoms, and the Z may be 0 to 1 Oxygen atoms. In select possibly preferred embodiments of this general formula of C(X) H(Y) O (Z) for the additive, the X may be 16 carbon atoms, the Y may be 34 hydrogen atoms, and the Z may be 0 to 1 oxygen atoms. The general formula of the additive deployed in the lead-acid battery may include compounds that are fully saturated and may be straight chain, branched chain or cycloalkane and isomeric derivatives thereof. The compounds of the additive may be deployed neat or as mixtures with other additives thereof.

In select embodiments of the disclosed lead-acid battery, the additive may be included in a battery separator of the lead-acid battery. The additive may be included in the battery separator of the lead-acid battery in many various locations and processes in the manufacture of the battery separator of the lead-acid battery. In select embodiments, the additive may be introduced into a separator manufacturing process of the battery separator during a polymer/filler extrusion operation either neat or as a mixture of pore forming agents. Wherein, the additive may have suitable solubility characteristics in the extraction solvent of the separator manufacturing process thus rendering the additive recoverable upon distillation-separation and amenable to deposition in a concentration controlled manner upon internal and external surfaces of the separator. In other select embodiments, the additive may be included in the battery separator as 0% to 100% of a pore forming agent concentration during the process of extrusion of the battery separator. In other select embodiments, the additive may be added directly and in a controlled manner to the extraction solvent during the extraction process to affect controlled deposition of the additive onto the external and internal surfaces of the battery separator. In other select embodiments, the additive may be applied to the finished battery separator in a controlled manner as a secondary manufacturing operation by means of spray, dip, immersion or other coating processes. In other select embodiments, the additive may be applied in its neat form to the battery separator at the completion of the production process by means of metered dose spray application technologies. In other select embodiments, the additive may be included in the battery separator in any combination of the embodiments listed above.

In select embodiments of the disclosed lead-acid battery, the additive may be not included in or with the battery separator of the lead-acid battery. Not including the additive in or with the battery separator may mitigate any occlusion or partial blockage of a porosity of the battery separator thus reducing electrical resistance within the battery during initial battery formation steps thereby optimizing the time and energy resources of the battery manufacturer during the critical formation process thereby benefitting the lead-acid manufacturing process. In select embodiments, the additive may be deployed directly on a positive electrode substrate or a negative electrode substrate utilized for bonding an active paste material to a lead grid electrode plate. This may benefit the lead-acid manufacturing process by providing a means to optimize the battery manufacture process through enhanced active material adhesion and enhanced plate cure energy resources. In other select embodiments, the additive may be included in the lead-acid battery in such a way as to engage a diffusion rate limiting release of additive over the extended cycle life of the battery. As an example, and clearly not limited thereto, the range of additive concentration applied per unit area of active material substrate may be 1 to 20 g/m̂2. In other select embodiments, the additive may be on a fibrous adsorptive or non-adsorptive oxidation resistant laminate material proximal to a positive electrode or a negative electrode of the lead-acid battery thereby benefitting the lead-acid battery manufacturing process, where the inclusion of said laminates within the battery design is economical approach to the enhancement of cycle life. As examples, and clearly not limited thereto, the range of additive concentration applied per unit area of fibrous adsorptive or non-adsorptive oxidation resistant laminate may be 1 to 20 g/m̂2. In other select embodiments, the additive may be applied to an additive bearing material that is a fibrous adsorptive or non-adsorptive oxidation resistant material that is configured to be placed within a case and not proximal to the electrodes. As examples, and clearly not limited thereto, the fibrous adsorptive or non-adsorptive oxidation resistant materials with the additive applied may be configured to be: used as a liner material corresponding to the periphery of the sides and bottom of the battery containment case; fixed in place by oxidation resistant adhesive materials; within the battery case as a free moving material without constraint of fixture; utilized in the injection molding process during battery containment case manufacture; and/or utilized in the injection molding process during electrolyte anti-stratification mixing component manufacture. Also as examples, and clearly not limited thereto, the range of additive concentration applied per unit area of the additive bearing material may be 1 to 20 g/m̂2. In other select embodiments, the additive may be added as a bolus directly into the battery cell electrolyte during the battery manufacturing and forming process. As examples, and clearly not limited thereto, the range of additive concentration applied per volumetric quantity of cell electrolyte may be 1 to 20 g/m̂2. In other select embodiments, the additive may be added as a time release module regulated by diffusion rate limiting encapsulation materials. As examples, and clearly not limited thereto, the time release encapsulation material may be comprised of: polyvinyl alcohol and derivatives thereof present in the current state of the art; cellulosic derivative materials thereof present in the current state of the art; porous polymeric discs or beads present in the current state of the art and not proximal to the electrode-separator assembly thereof, where the porous polymer discs or beads can be comprised of PP, HDPE, UHMWPE, PVC, PVA, PVDF, PTFE, PES, PESO. As examples, and clearly not limited thereto, the range of additive concentration applied per volumetric quantity of cell electrolyte may be 1 to 20 g/m̂2. In other select embodiments, the additive may be included or deployed in the lead-acid battery in any combination of the embodiments listed above.

In another aspect, the instant disclosure embraces a battery separator for a lead-acid battery. The battery separator for the lead-acid battery may generally include an additive configured to mitigate water loss and destructive processes within the lead-acid battery as a result of the water loss. The additive may be included in the battery separator to address deleterious effects to critical battery performance features brought about by a sustained reduction in battery electrolyte volume over a service life of the lead-acid battery. As examples, and clearly not limited thereto, the additive included in or with the battery separator may be configured to suppress a rate of water loss over a service life of the lead-acid battery resulting in a reduced level of electrolyte leading to dry-out, thus exposing battery component weld points, electrode plates and connections leading to accelerated corrosion, increasing an electrolyte acid concentration, a negative electrode sulfation and a positive electrode grid corrosion and an excessive outgassing of H2 and O2 gasses. As a result, the consequences of water loss may affect key battery performance features including an energy storage capacity, a cold cranking amperage, a hazardous gas venting, and a marked reduction in cycling or service life.

In select embodiments of the battery separator of the instant disclosure, the additive included with or in the battery separator may have a general formula of: C(X) H(Y) O (Z). In select embodiments of this general formula of C(X) H(Y) O (Z) for the additive, the X may be 8 to 18 carbon atoms, the Y may be 1 to 38 hydrogen atoms, and the Z may be 0 to 1 oxygen atoms. In other select embodiments of this general formula of C(X) H(Y) O (Z) for the additive, the X may be 12 to 16 carbon atoms, the Y may be 26 to 34 hydrogen atoms, and the Z may be 0 to 1 Oxygen atoms. In select possibly preferred embodiments of this general formula of C(X) H(Y) O (Z) for the additive, the X may be 16 carbon atoms, the Y may be 34 hydrogen atoms, and the Z may be 0 to 1 oxygen atoms. The general formula of the additive included in or with the battery separator may include compounds that are fully saturated and may be straight chain, branched chain or cycloalkane and isomeric derivatives thereof. The compounds of the additive may be deployed neat or as mixtures with other additives thereof in or on the battery separator.

The additive may be included in, on or with the battery separator of the lead-acid battery in many various locations and processes in the manufacture of the battery separator of the lead-acid battery. In select embodiments, the additive may be introduced into a separator manufacturing process of the battery separator during a polymer/filler extrusion operation either neat or as a mixture of pore forming agents. Wherein, the additive may have suitable solubility characteristics in the extraction solvent of the separator manufacturing process thus rendering the additive recoverable upon distillation-separation and amenable to deposition in a concentration controlled manner upon internal and external surfaces of the separator. In other select embodiments, the additive may be included in the battery separator as 0% to 100% of a pore forming agent concentration during the process of extrusion of the battery separator. In other select embodiments, the additive may be added directly and in a controlled manner to the extraction solvent during the extraction process to affect controlled deposition of the additive onto the external and internal surfaces of the battery separator. In other select embodiments, the additive may be applied to the finished battery separator in a controlled manner as a secondary manufacturing operation by means of spray, dip, immersion or other coating processes. In other select embodiments, the additive may be applied in its neat form to the battery separator at the completion of the production process by means of metered dose spray application technologies. In other select embodiments, the additive may be included in the battery separator in any combination of the embodiments listed above.

In yet another aspect, the instant disclosure embraces a method of mitigating water loss in a lead-acid battery. The disclosed method of mitigating water loss in a lead-acid battery may generally include the step of deploying an additive in the lead-acid battery configured to mitigate water loss and destructive processes within the lead-acid battery as a result of the water loss. Wherein the additive may be deployed in the lead-acid battery to address deleterious effects to critical battery performance features brought about by a sustained reduction in battery electrolyte volume over a service life of the lead-acid battery. The additive deployed in the disclosed method of mitigating water loss in a lead-acid battery may be configured to suppress a rate of water loss over a service life of the lead-acid battery resulting in a reduced level of electrolyte leading to dry-out, thus exposing battery component weld points, electrode plates and connections leading to accelerated corrosion, increasing an electrolyte acid concentration, a negative electrode sulfation and a positive electrode grid corrosion and an excessive outgassing of H2 and O2 gasses, whereby the consequences of water loss affect key battery performance features including an energy storage capacity, a cold cranking amperage, a hazardous gas venting, and a marked reduction in cycling or service life.

In select embodiments of the method of mitigating water loss in a lead-acid battery of the instant disclosure, the additive deployed in the lead-acid battery may have a general formula of: C(X) H(Y) O (Z). In select embodiments of this general formula of C(X) H(Y) O (Z) for the additive, the X may be 8 to 18 carbon atoms, the Y may be 1 to 38 hydrogen atoms, and the Z may be 0 to 1 oxygen atoms. In other select embodiments of this general formula of C(X) H(Y) O (Z) for the additive, the X may be 12 to 16 carbon atoms, the Y may be 26 to 34 hydrogen atoms, and the Z may be 0 to 1 Oxygen atoms. In select possibly preferred embodiments of this general formula of C(X) H(Y) O (Z) for the additive, the X may be 16 carbon atoms, the Y may be 34 hydrogen atoms, and the Z may be 0 to 1 oxygen atoms. The general formula of the additive included in or with the method of mitigating water loss in a lead-acid battery may include compounds that are fully saturated and may be straight chain, branched chain or cycloalkane and isomeric derivatives thereof. The compounds of the additive may be deployed neat or as mixtures with other additives thereof in or on the battery separator.

In select embodiments of the disclosed method of mitigating water loss in a lead-acid battery, the step of deploying the additive in the lead-acid battery may include adding the additive with a battery separator of the lead-acid battery. This step of adding the additive with the battery separator may include the following steps, or a combination thereof: introducing the additive into a separator manufacturing process of the battery separator during a polymer/filler extrusion operation either neat or as a mixture of pore forming agents, wherein the additive has suitable solubility characteristics in the extraction solvent of the separator manufacturing process thus rendering the additive recoverable upon distillation-separation and amenable to deposition in a concentration controlled manner upon internal and external surfaces of the separator; including 0% to 100% of a pore forming agent concentration during the process of extrusion of the battery separator; adding the additive directly and in a controlled manner to the extraction solvent during the extraction process to affect controlled deposition of the additive onto the external and internal surfaces of the battery separator; applying the additive to the finished battery separator in a controlled manner as a secondary manufacturing operation by means of spray, dip, immersion or other coating processes; and/or applying the additive in its neat form to the battery separator at the completion of the production process by means of metered dose spray application technologies.

In select embodiments of the disclosed method of mitigating water loss in a lead-acid battery, the step of deploying the additive in the lead-acid battery may include the steps of, or a combination thereof: not including the additive with a battery separator of the lead-acid battery thereby mitigating any occlusion or partial blockage of a porosity of the battery separator thus reducing electrical resistance within the battery during initial battery formation steps thereby optimizing the time and energy resources of the battery manufacturer during the critical formation process thereby benefitting the lead-acid manufacturing process; applying the additive directly on a positive electrode substrate or a negative electrode substrate utilized for bonding an active paste material to a lead grid electrode plate, thereby benefitting the lead-acid manufacturing process by providing a means to optimize the battery manufacture process through enhanced active material adhesion and enhanced plate cure energy resources; including the additive in the lead-acid battery in such a way as to engage a diffusion rate limiting release of additive over the extended cycle life of the battery, wherein the range of additive concentration applied per unit area of active material substrate is 1 to 20 g/m̂2; adding the additive on a fibrous adsorptive or non-adsorptive oxidation resistant laminate material proximal to a positive electrode or a negative electrode of the lead-acid battery thereby benefitting the lead-acid battery manufacturing process, where the inclusion of said laminates within the battery design is an economical approach to the enhancement of cycle life, whereby the range of additive concentration added per unit area of fibrous adsorptive or non-adsorptive oxidation resistant laminate is 1 to 20 g/m̂2; applying the additive to an additive bearing material that is a fibrous adsorptive or non-adsorptive oxidation resistant material that is configured to be placed within a case and not proximal to the electrodes, wherein the fibrous adsorptive or non-adsorptive oxidation resistant materials with the additive applied are configured to be used as a liner material corresponding to the periphery of the sides and bottom of the battery containment case, fixed in place by oxidation resistant adhesive materials, within the battery case as a free moving material without constraint of fixture, utilized in the injection molding process during battery containment case manufacture, or utilized in the injection molding process during electrolyte anti-stratification mixing component manufacture, whereby the range of additive concentration applied per unit area of the additive bearing material is 1 to 20 g/m̂2; adding the additive as a bolus directly into the battery cell electrolyte during the battery manufacturing and forming process, where the range of additive concentration applied per volumetric quantity of cell electrolyte is 1 to 20 g/m̂2; and/or adding the additive as a time release module regulated by diffusion rate limiting encapsulation materials, where the time release encapsulation material is comprised of polyvinyl alcohol and derivatives thereof present in the current state of the art, cellulosic derivative materials thereof present in the current state of the art, porous polymeric discs or beads present in the current state of the art and not proximal to the electrode-separator assembly thereof, where the porous polymer discs or beads can be comprised of PP, HDPE, UHMWPE, PVC, PVA, PVDF, PTFE, PES, PESO, where the range of additive concentration applied per volumetric quantity of cell electrolyte is 1 to 20 g/m̂2.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 illustrates a lead-acid battery with a cut away portion showing the internal components of the lead-acid battery for utilizing the additive according to select embodiments of the instant disclosure;

FIG. 2 illustrates a bar graph of the results a 42 Day Cell Overcharge Test with a control compared to various additive formulations according to select embodiments of the instant disclosure; and

FIG. 3 illustrates a flow chart of the method of mitigating water loss in a lead-acid battery according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

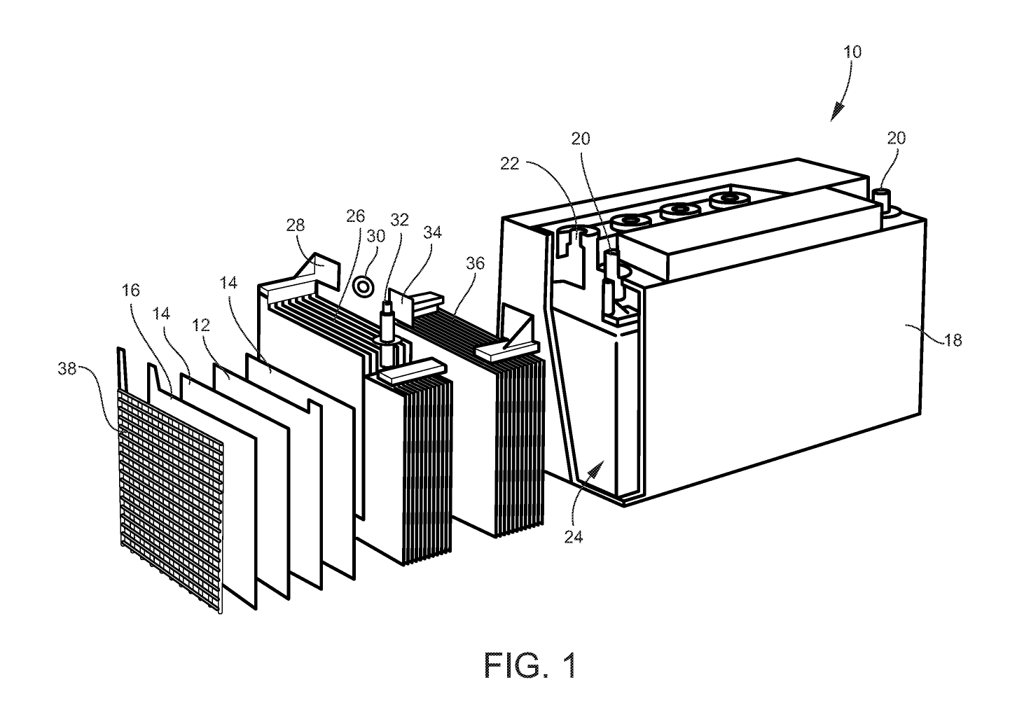

Referring now to FIGS. 1-3, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure may be generally directed to battery separators, components, lead-acid batteries, systems, and/or related methods of production and/or use thereof, including additives for use with a battery separator for use in a lead-acid battery. In at least select embodiments, the instant disclosure relates to new or improved lead-acid battery separators and/or systems including improved water loss technology and/or methods of manufacture and/or use thereof. In at least select embodiments, the instant disclosure is directed toward a new or improved lead-acid battery separator or system with one additive, or a mixture of additives, and/or methods for constructing lead-acid battery separators and batteries with such additives for improving and/or reducing water loss from the battery.

Referring now to FIG. 1, in a possibly preferred embodiment, the present disclosure overcomes the above-mentioned disadvantages and meets the recognized need for such an apparatus or method by providing of lead-acid battery 10. Lead-acid battery 10 may be any size or type of lead-acid battery, including, but not limited to, an enhanced flooded battery (“EFB”), as shown in FIG. 1. As shown, battery 10 includes negative plate (electrode) 12 and positive plate (electrode) 16 with separator 14 sandwiched there between. These components are housed within container, case or housing 18 that also includes terminal posts 20, valve adapter and valve 22, and electrolyte 24. A positive plate pack is shown with positive cell connection 28 and a negative pole 32. A negative plate pack 36 is shown with a negative cell connection 34. An electrolyte tight sealing ring 30 is shown for sealing electrolyte 24. Also shown is grid plate 38. Although a particular battery is shown, the inventive additive may be used in many different types of batteries or devices including for example, but not limited to, sealed lead-acid, flooded lead-acid, ISS lead-acid, combined battery and capacitor units, other battery types, capacitors, accumulators, and/or the like.

Lead-acid battery 10 may generally include the inventive additive deployed therein. The additive deployed in lead-acid battery may be configured to mitigate water loss and destructive processes within lead-acid battery 10 as a result of the water loss. The additive may be deployed in lead-acid battery 10 to address deleterious effects to critical battery performance features brought about by a sustained reduction in battery electrolyte 24 volume over a service life of the lead-acid battery. As examples, and clearly not limited thereto, the additive deployed in lead-acid battery 10 may be configured to suppress a rate of water loss over a service life of lead-acid battery 10 resulting in a reduced level of electrolyte 24 leading to dry-out, thus exposing battery component weld points, electrode plates (12, 16, 38) and connections (28, 32, 34) leading to accelerated corrosion, increasing an electrolyte acid concentration, a negative electrode sulfation and a positive electrode grid 38 corrosion and an excessive outgassing of H2 and O2 gasses. As a result, the consequences of water loss may affect key battery performance features including an energy storage capacity, a cold cranking amperage, a hazardous gas venting, and a marked reduction in cycling or service life.

The additive deployed in lead-acid battery 10 may have a general formula of: C(X) H(Y) O (Z). In select embodiments of this general formula of C(X) H(Y) O (Z) for the additive, the X may be 8 to 18 carbon atoms, the Y may be 1 to 38 hydrogen atoms, and the Z may be 0 to 1 oxygen atoms. In other select embodiments of this general formula of C(X) H(Y) O (Z) for the additive, the X may be 12 to 16 carbon atoms, the Y may be 26 to 34 hydrogen atoms, and the Z may be 0 to 1 Oxygen atoms. In select possibly preferred embodiments of this general formula of C(X) H(Y) O (Z) for the additive, the X may be 16 carbon atoms, the Y may be 34 hydrogen atoms, and the Z may be 0 to 1 oxygen atoms. The general formula of the additive deployed in lead-acid battery 10 may include compounds that are fully saturated and may be straight chain, branched chain or cycloalkane and isomeric derivatives thereof. The compounds of the additive may be deployed neat or as mixtures with other additives thereof.

The additive may be included in battery separator 14 of lead-acid battery 10. The additive may be included in battery separator 14 of lead-acid battery 10 in many various locations and processes in the manufacture of battery separator 14 of lead-acid battery 10. In select embodiments, the additive may be introduced into a separator manufacturing process of battery separator 14 during a polymer/filler extrusion operation either neat or as a mixture of pore forming agents. Wherein, the additive may have suitable solubility characteristics in the extraction solvent of the separator manufacturing process thus rendering the additive recoverable upon distillation-separation and amenable to deposition in a concentration controlled manner upon internal and external surfaces of the separator. In other select embodiments, the additive may be included in battery separator 14 as 0% to 100% of a pore forming agent concentration during the process of extrusion of battery separator 14. In other select embodiments, the additive may be added directly and in a controlled manner to the extraction solvent during the extraction process to affect controlled deposition of the additive onto the external and internal surfaces of battery separator 14. In other select embodiments, the additive may be applied to the finished battery separator 14 in a controlled manner as a secondary manufacturing operation by means of spray, dip, immersion or other coating processes. In other select embodiments, the additive may be applied in its neat form to the battery separator 14 at the completion of the production process by means of metered dose spray application technologies. In other select embodiments, the additive may be included in the battery separator in any combination of the embodiments listed above.

In addition or alternatively to including the additive in, on or with battery separator 14, the additive may be not included in or with battery separator 14 of lead-acid battery 10. Not including the additive in or with battery separator 14 may mitigate any occlusion or partial blockage of a porosity of battery separator 14 thus reducing electrical resistance within battery 10 during initial battery formation steps thereby optimizing the time and energy resources of the battery manufacturer during the critical formation process thereby benefitting the lead-acid manufacturing process. In select embodiments, the additive may be deployed directly on positive electrode 16 substrate or a negative electrode 12 substrate utilized for bonding an active paste material to lead grid electrode plate 38. This may benefit the lead-acid manufacturing process by providing a means to optimize the battery manufacture process through enhanced active material adhesion and enhanced plate cure energy resources. In other select embodiments, the additive may be included in lead-acid battery 10 in such a way as to engage a diffusion rate limiting release of additive over the extended cycle life of the battery. As an example, and clearly not limited thereto, the range of additive concentration applied per unit area of active material substrate may be 1 to 20 g/m̂2. In other select embodiments, the additive may be on a fibrous adsorptive or non-adsorptive oxidation resistant laminate material proximal to positive electrode 16 or negative electrode 12 of lead-acid battery 10 thereby benefitting the lead-acid battery manufacturing process, where the inclusion of said laminates within battery 10 design is economical approach to the enhancement of cycle life. As examples, and clearly not limited thereto, the range of additive concentration applied per unit area of fibrous adsorptive or non-adsorptive oxidation resistant laminate may be 1 to 20 g/m̂2. In other select embodiments, the additive may be applied to an additive bearing material that is a fibrous adsorptive or non-adsorptive oxidation resistant material that is configured to be placed within case or container 18 and not proximal to electrodes 12 and 16. As examples, and clearly not limited thereto, the fibrous adsorptive or non-adsorptive oxidation resistant materials with the additive applied may be configured to be: used as a liner material corresponding to the periphery of the sides and bottom of the battery containment case 18; fixed in place by oxidation resistant adhesive materials; within the battery case 18 as a free moving material without constraint of fixture; utilized in the injection molding process during battery containment case 18 manufacture; and/or utilized in the injection molding process during electrolyte 24 anti-stratification mixing component manufacture. Also as examples, and clearly not limited thereto, the range of additive concentration applied per unit area of the additive bearing material may be 1 to 20 g/m̂2. In other select embodiments, the additive may be added as a bolus directly into the battery cell electrolyte 24 during the battery manufacturing and forming process. As examples, and clearly not limited thereto, the range of additive concentration applied per volumetric quantity of cell electrolyte 24 may be 1 to 20 g/m̂2. In other select embodiments, the additive may be added as a time release module regulated by diffusion rate limiting encapsulation materials. As examples, and clearly not limited thereto, the time release encapsulation material may be comprised of: polyvinyl alcohol and derivatives thereof present in the current state of the art; cellulosic derivative materials thereof present in the current state of the art; porous polymeric discs or beads present in the current state of the art and not proximal to the electrode-separator assembly thereof, where the porous polymer discs or beads can be comprised of PP, HDPE, UHMWPE, PVC, PVA, PVDF, PTFE, PES, PESO. As examples, and clearly not limited thereto, the range of additive concentration applied per volumetric quantity of cell electrolyte 24 may be 1 to 20 g/m̂2. In other select embodiments, the additive may be included or deployed in the lead-acid battery 10 in any combination of the embodiments listed above.

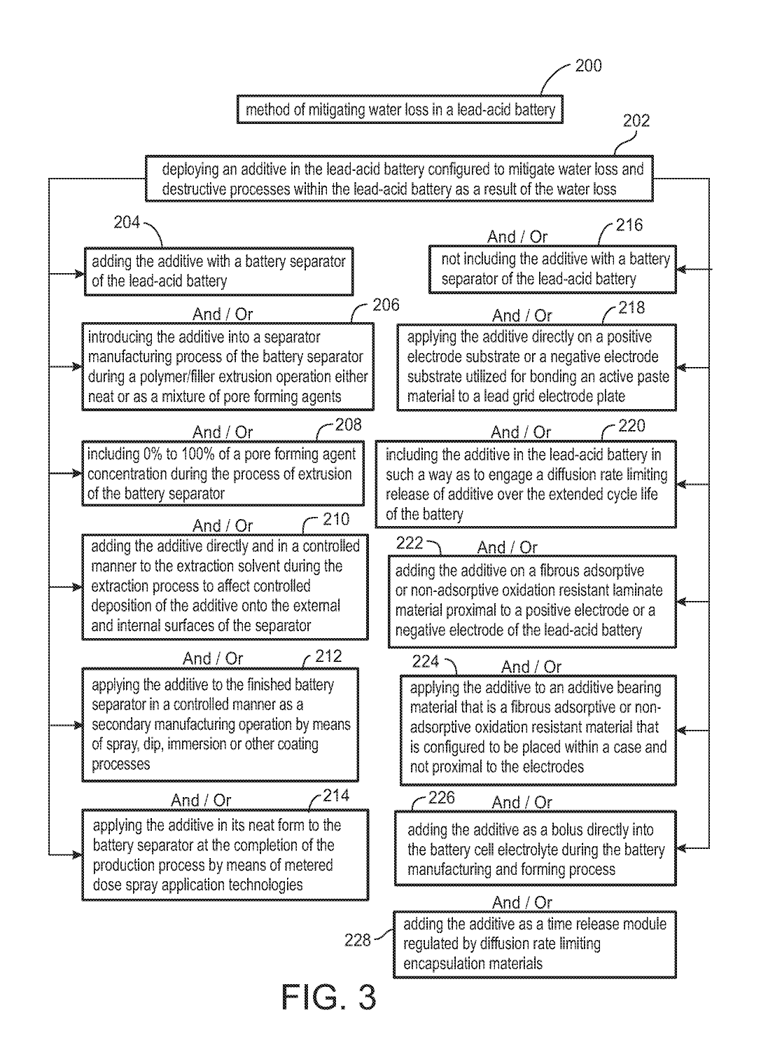

Referring now to FIG. 3, method 200 of mitigating water loss in lead-acid battery 10 is shown. Method 200 of mitigating water loss in lead-acid battery 10 may generally include step 202 of deploying the disclosed additive in lead-acid battery 10 configured to mitigate water loss and destructive processes within lead-acid battery 10 as a result of the water loss. Wherein the additive may be deployed in the lead-acid battery to address deleterious effects to critical battery performance features brought about by a sustained reduction in battery electrolyte 24 volume over a service life of the lead-acid battery. The additive deployed in method 200 of mitigating water loss in lead-acid battery 10 may be configured to suppress a rate of water loss over a service life of lead-acid battery 10 resulting in a reduced level of electrolyte 24 leading to dry-out, thus exposing battery component weld points, electrode plates (12, 16, 38) and connections leading to accelerated corrosion, increasing an electrolyte acid concentration, a negative electrode 12 sulfation and a positive electrode grid 38 corrosion and an excessive outgassing of H2 and O2 gasses, whereby the consequences of water loss affect key battery performance features including an energy storage capacity, a cold cranking amperage, a hazardous gas venting, and a marked reduction in cycling or service life.

In select embodiments of method 200 of mitigating water loss in lead-acid battery 10 of the instant disclosure, the additive deployed in lead-acid battery 10 may have a general formula of: C(X) H(Y) O (Z). In select embodiments of this general formula of C(X) H(Y) O (Z) for the additive, the X may be 8 to 18 carbon atoms, the Y may be 1 to 38 hydrogen atoms, and the Z may be 0 to 1 oxygen atoms. In other select embodiments of this general formula of C(X) H(Y) O (Z) for the additive, the X may be 12 to 16 carbon atoms, the Y may be 26 to 34 hydrogen atoms, and the Z may be 0 to 1 Oxygen atoms. In select possibly preferred embodiments of this general formula of C(X) H(Y) O (Z) for the additive, the X may be 16 carbon atoms, the Y may be 34 hydrogen atoms, and the Z may be 0 to 1 oxygen atoms. The general formula of the additive included in or with method 200 of mitigating water loss in lead-acid battery 10 may include compounds that are fully saturated and may be straight chain, branched chain or cycloalkane and isomeric derivatives thereof. The compounds of the additive may be deployed neat or as mixtures with other additives thereof in or on battery separator 14.

In select embodiments of method 200 of mitigating water loss in lead-acid battery 10, step 202 of deploying the additive in lead-acid battery 10 may include step 204 of adding the additive with battery separator 14 of lead-acid battery 10. This step 204 of adding the additive with battery separator 14 may include the following steps, or a combination thereof: step 206 of introducing the additive into a separator manufacturing process of battery separator 14 during a polymer/filler extrusion operation either neat or as a mixture of pore forming agents, wherein the additive has suitable solubility characteristics in the extraction solvent of the separator manufacturing process thus rendering the additive recoverable upon distillation-separation and amenable to deposition in a concentration controlled manner upon internal and external surfaces of the separator 14; step 208 of including 0% to 100% of a pore forming agent concentration during the process of extrusion of battery separator 14; step 210 of adding the additive directly and in a controlled manner to the extraction solvent during the extraction process to affect controlled deposition of the additive onto the external and internal surfaces of battery separator 14; step 212 of applying the additive to the finished battery separator 14 in a controlled manner as a secondary manufacturing operation by means of spray, dip, immersion or other coating processes; and/or step 214 of applying the additive in its neat form to battery separator 14 at the completion of the production process by means of metered dose spray application technologies.

In select embodiments of method 200 of mitigating water loss in lead-acid battery 10, step 202 of deploying the additive in lead-acid battery 10 may include the steps of, or a combination thereof: step 216 of not including the additive with battery separator 14 of lead-acid battery 10 thereby mitigating any occlusion or partial blockage of a porosity of battery separator 14 thus reducing electrical resistance within battery 10 during initial battery formation steps thereby optimizing the time and energy resources of the battery manufacturer during the critical formation process thereby benefitting the lead-acid manufacturing process; step 218 of applying the additive directly on positive electrode 16 substrate or negative electrode 12 substrate utilized for bonding an active paste material to a lead grid electrode plate 38, thereby benefitting the lead-acid manufacturing process by providing a means to optimize the battery manufacture process through enhanced active material adhesion and enhanced plate cure energy resources; step 220 of including the additive in lead-acid battery 10 in such a way as to engage a diffusion rate limiting release of additive over the extended cycle life of the battery, wherein the range of additive concentration applied per unit area of active material substrate is 1 to 20 g/m̂2; step 222 of adding the additive on a fibrous adsorptive or non-adsorptive oxidation resistant laminate material proximal to positive electrode 16 or negative electrode 12 of lead-acid battery 10 thereby benefitting the lead-acid battery manufacturing process, where the inclusion of said laminates within the battery design is an economical approach to the enhancement of cycle life, whereby the range of additive concentration added per unit area of fibrous adsorptive or non-adsorptive oxidation resistant laminate is 1 to 20 g/m̂2; step 224 of applying the additive to an additive bearing material that is a fibrous adsorptive or non-adsorptive oxidation resistant material that is configured to be placed within case 18 and not proximal to electrodes 12 and 16, wherein the fibrous adsorptive or non-adsorptive oxidation resistant materials with the additive applied are configured to be used as a liner material corresponding to the periphery of the sides and bottom of the battery containment case 18, fixed in place by oxidation resistant adhesive materials, within the battery case 18 as a free moving material without constraint of fixture, utilized in the injection molding process during battery containment case 18 manufacture, or utilized in the injection molding process during electrolyte 24 anti-stratification mixing component manufacture, whereby the range of additive concentration applied per unit area of the additive bearing material is 1 to 20 g/m̂2; step 226 of adding the additive as a bolus directly into the battery cell electrolyte 24 during the battery manufacturing and forming process, where the range of additive concentration applied per volumetric quantity of cell electrolyte is 1 to 20 g/m̂2; and/or step 228 of adding the additive as a time release module regulated by diffusion rate limiting encapsulation materials, where the time release encapsulation material is comprised of polyvinyl alcohol and derivatives thereof present in the current state of the art, cellulosic derivative materials thereof present in the current state of the art, porous polymeric discs or beads present in the current state of the art and not proximal to the electrode-separator assembly thereof, where the porous polymer discs or beads can be comprised of PP, HDPE, UHMWPE, PVC, PVA, PVDF, PTFE, PES, PESO, where the range of additive concentration applied per volumetric quantity of cell electrolyte is 1 to 20 g/m̂2.

In sum, the instant disclosure may address at least certain aspects of the above mentioned needs, issues and/or problems and may provide new or improved lead-acid battery 10 and battery separator 14 for lead-acid battery 10. In general, the instant disclosure may provide new or improved lead-acid battery separator 14 and/or methods of manufacture and/or use thereof. In at least select embodiments, the instant disclosure may provide one or more additives for battery separator 14 and/or for a lead-acid battery system 10, as well as methods 200 for constructing lead-acid battery separators 14 and/or battery systems 10 including such additives for improving and/or reducing water loss for a lead-acid battery. In one embodiment, method 200 of improving and/or reducing water loss of lead-acid battery 10 may include providing separator 14 as well as an additive where the additive component may improve and/or reduce water loss for the system.

The present disclosure may thus provide an additive to be used in conjunction with lead-acid battery separator 14, and lead-acid battery 10 or battery system having such a separator 14 with an additive. As such, the instant disclosure may provide lead-acid battery 10 with reduced water loss.

In select embodiments, the various additives used herein may be stable under conditions required to manufacture a UHMWPE (ultrahigh molecular weight polyethylene) battery separator.

In select embodiments, the various additives used herein may exhibit some solubility characteristics in various extraction solvents currently used (or viable alternatives thereto) in typical separator manufacturing processes. As such, the various additives described herein may be coated or spray-applied to the separator surface.

In select embodiments, the various additives used herein may be added anytime within the separator manufacturing process. As such, the various additives described herein may be applied within the battery or other components as a supplement to separator 14 or in place thereof. As examples, and clearly not limited thereto: the various additives described herein may be provided with electrolyte 24 as a pre-mix or added as a stand-alone to the cell; the additive may be coated on separator 14 to achieve the desired concentration; the additive may be mixed with pore forming oil/solvent and infused into separator 14 during normal manufacturing steps; the additive may be utilized neat or be mixed with other raw materials of the manufacturing process and remain in separator 14 at the desired level through the end of the process, thus the additive may constitute a portion of the normal residual pore forming agent left within separator 14; the like; and/or combinations thereof. The various additives and mixtures thereof used herein may be provided in various amounts in or on separator 14 to achieve the desired reduction or improvement in water loss. In select embodiments, the additive may be between 1 to 100% of the total residual pore forming agents left within separator 14. In other select embodiments, the additive may be between 1 to 50% of the total residual pore forming agents left within separator 14. In other embodiments, the additive may be approximately 20% of the residual pore forming agents left within separator 14. The additive may also be applied in its neat form to separator 14 at the completion of the production process by means of metered dose spray application technologies known to those skilled in the art.

Also, in various embodiments, battery separator 14 may be based on a thermoplastic, such as a polyolefin or an ultra-high molecular weight polyolefin, such as one with an average molecular weight of at least 300,000.

Examples of additives of the instant disclosure, which may be soluble in organic extraction solvents and/or amenable to spray application technologies and may be included with battery separator 14, are the following naturally or synthetically derived family of straight chain and/or branched chain saturated hydrocarbons and their respective monofunctional primary alcohols:

C(x) H(y) O (z) where x=8 to 18 and y=18 to 38 and z=0 to 1;

Possibly preferred may be:

C(x) H(y) O (z) where x=12 to 16 and y=26 to 34 and z=0 to 1;

And possibly most preferred may be:

C(x) H(y) O (z) where x=16 and y=34 and z=0 to 1.

Lead-acid battery 10 may be provided, made, or manufactured according to the instant disclosure with any of the various embodiments of the various additives as shown and/or described herein. Lead-acid battery 10, like a flooded lead-acid battery, or an EFB, may be improved with any of the various embodiments of the additives as shown and/or described herein. The improvements of lead-acid battery 10, with any of the various embodiments of the additives as shown and/or described herein, may include, but are not limited to, having reduced and/or improved water loss.

The instant disclosure also provides method 200 of mitigating or reducing water loss of lead-acid battery 10. Method 200 may include providing one or more additives according to any of the various embodiments shown and/or described herein. In select embodiments, method 200 of mitigating or reducing water loss of lead-acid battery 10 may include reducing vapor loss from the vented lead-acid battery 10. In select embodiments of method 200 of mitigating or reducing water loss of lead-acid battery 10, the multifunctional pore forming agents or additive may be provided in or on battery separator 14.

Additionally, the systems of the present disclosure may be optimized such that there is little or no impact on the electrical resistance of the system. The systems described herein may be designed to extend the life cycle of battery 10 as well as reserve capacity and help with optimizing CCA.

As examples, and clearly not limited thereto, the various additives described herein may reduce the float current, and/or may reduce the level of gas evolution on charge, which may result in loss of water from fugitive Hydrogen gas from electrolyte 24.

### EXAMPLES

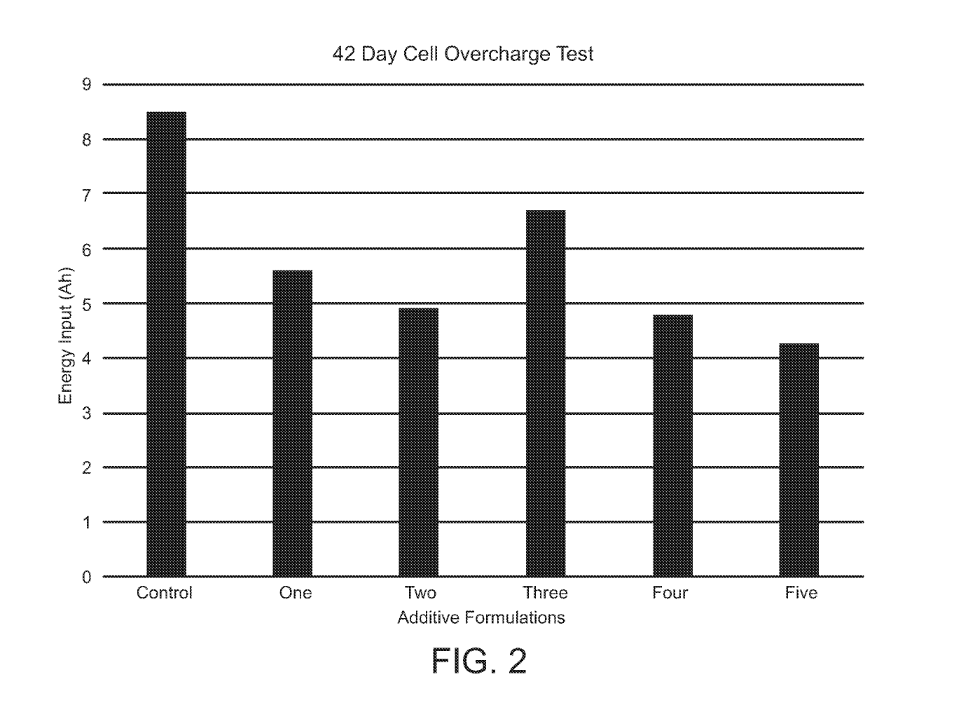

In order to quantify the degree of water loss over a given set of battery cell parameters, a proven screening test procedure is utilized and known to those skilled in the art. The screening procedure involves building a standard battery cell, usually a total of 5 to 9 plates constitute the cell. The composition of the electrode plate (active material) can be selected depending on the test objective. In the case of the innovative additives described herein, commercially available “SLI” electrode plates (Ca/Ca) were selected for screening additive performance. The data in FIG. 2, corresponds to the aforementioned screening procedure. The control lacks any additive modification. The samples represent battery separators 14 treated with additives described herein and within the range of chemical formulas described herein. DuroForce ULR battery separator 14 for EFB applications, provided by Microporous LLC of Piney Flats, Tenn., was utilized over all screening tests. DuroForce ULR is a UHMWPE separator membrane.

### Example 1

Formulation 1 in FIG. 2 represents performance vs control for an additive near the lowest number of carbon atoms claimed herein. Surprisingly, water loss performance exhibits only moderate sensitivity over the range of carbon atoms as described herein.

### Example 2

Formulation 2 & 3 in FIG. 2 represent performance vs control for additives of the same number of carbon atoms. Formulations 2 & 3 represent a modest increase in the number of Carbon atoms vs that described in Example 1 and vary only in the presence or absence of an Oxygen atom. The results showed that the presence of an Oxygen atom in the additive formula results in marked change in water loss performance.

### Example 3

Formulation 4 & 5 in FIG. 2 represent performance vs control for additives of the same number of carbon atoms and varying only in the presence or absence of an Oxygen atom. In the case of formulations 4 & 5 however, the number of Carbon atoms is near the upper limit of the range claimed herein. As in Example 2, there is a notable change in water loss performance between the two formulations. However, the results showed that it has been observed that the change in performance vs control upon the addition of an Oxygen atom in the formula diminishes with increasing number of Carbon atoms.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A lead-acid battery comprising:
an additive deployed in the lead-acid battery configured to mitigate water loss and destructive processes within the lead-acid battery as a result of the water loss;
wherein the additive is deployed in the lead-acid battery to address deleterious effects to critical battery performance features brought about by a sustained reduction in a battery electrolyte volume over a service life of the lead-acid battery.

2. The lead-acid battery of claim 1, wherein the additive deployed in the lead-acid battery is configured to suppress a rate of water loss over the service life of the lead-acid battery resulting in a reduced level of electrolyte leading to dry-out, thus exposing battery component weld points, electrode plates and connections leading to accelerated corrosion, increasing an electrolyte acid concentration, a negative electrode sulfation and a positive electrode grid corrosion and an excessive outgassing of H2 and 02 gasses, whereby consequences of water loss affect key battery performance features including an energy storage capacity, a cold cranking amperage, a hazardous gas venting, and a marked reduction in cycling or the service life.

3. The lead-acid battery of claim 1, where the additive deployed in the lead-acid battery has a general formula of:
C_{(X)} H_{(Y)} O_{(Z)};
where X=8 to 18 carbon atoms;
where Y=1 to 38 hydrogen atoms; and
where Z=0 to 1 oxygen atoms.

4. The lead-acid battery of claim 3 where the general formula of the additive deployed in the lead-acid battery is:
C_{(X)}H_{(Y)} O_{(Z)};
where X=12 to 16 carbon atoms;
where Y=26 to 34 hydrogen atoms; and
where Z=0 to 1 Oxygen atoms.

5. The lead-acid battery of claim 4 where the general formula of the additive deployed in the lead-acid battery is:
C_{(X)} H_{(Y)} O_{(Z)};
where X=16 carbon atoms;
where Y=34 hydrogen atoms; and
where Z=0 to 1 oxygen atoms.

6. The lead-acid battery of claim 3, where the general formula of the additive deployed in the lead-acid battery includes compounds that are fully saturated and may be straight chain, branched chain or cycloalkane and isomeric derivatives thereof, where the compounds of the additive are deployed neat or as mixtures with other additives thereof.

7. The lead-acid battery of claim 1, where the additive is included in a battery separator of the lead-acid battery.

8. The lead-acid battery of claim 7, wherein the additive included in the battery separator of the lead-acid battery:
is introduced into a separator manufacturing process of the battery separator during a polymer/filler extrusion operation either neat or as a mixture of pore forming agents, wherein the additive has suitable solubility characteristics in an extraction solvent of the separator manufacturing process thus rendering the additive recoverable upon distillation-separation and amenable to deposition in a concentration controlled manner upon internal and external surfaces of the separator;
comprises 0% to 100% of a pore forming agent concentration during a process of extrusion of the battery separator;
is added directly and in a controlled manner to the extraction solvent during an extraction process to affect controlled deposition of the additive onto the external and internal surfaces of the battery separator;
is applied to the finished battery separator in a controlled manner as a secondary manufacturing operation by means of spray, dip, immersion or other coating processes; or
is applied in its neat form to the battery separator at a completion of the production process by means of metered dose spray application technologies.

9. The lead-acid battery of claim 1, wherein:
the additive is not included with a battery separator of the lead-acid battery thereby mitigating any occlusion or partial blockage of a porosity of the battery separator thus reducing electrical resistance within the lead-acid battery during initial battery formation steps thereby optimizing time and energy resources of the battery manufacturer during a critical formation process thereby benefitting a lead-acid manufacturing process;
the additive is directly on a positive electrode substrate or a negative electrode substrate utilized for bonding an active paste material to a lead grid electrode plate, thereby benefitting the lead-acid manufacturing process by providing a means to optimize a battery manufacture process through enhanced active material adhesion and enhanced plate cure energy resources;
the additive is included in the lead-acid battery in such a way as to engage a diffusion rate limiting release of additive over an extended cycle life of the lead-acid battery, wherein the range of additive concentration applied per unit area of active material substrate is 1 to 20 g/m̂2;
the additive is on a fibrous adsorptive or non-adsorptive oxidation resistant laminate material proximal to a positive electrode or a negative electrode of the lead-acid battery thereby benefitting the lead-acid battery manufacturing process, whereby the range of additive concentration applied per unit area of fibrous adsorptive or non-adsorptive oxidation resistant laminate is 1 to 20 g/m̂2;
the additive is applied to an additive bearing material that is a fibrous adsorptive or non-adsorptive oxidation resistant material that is configured to be placed within a case and not proximal to the electrodes, wherein the fibrous adsorptive or non-adsorptive oxidation resistant material with the additive applied are configured to be:
used as a liner material corresponding to the periphery of the sides and bottom of the battery containment case;
fixed in place by oxidation resistant adhesive materials;
within the battery case as a free moving material without constraint of fixture;
utilized in an injection molding process during battery containment case manufacture; or
utilized in the injection molding process during electrolyte anti-stratification mixing component manufacture;
whereby the range of additive concentration applied per unit area of the additive fibrous adsorptive or non-adsorptive oxidation resistant material is 1 to 20 g/m̂2;
the additive is added as a bolus directly into a battery cell electrolyte during the battery manufacturing and forming process, where the range of additive concentration applied per volumetric quantity of the battery cell electrolyte is 1 to 20 g/m̂2;
the additive is added as a time release module regulated by diffusion rate limiting encapsulation materials; where the time release encapsulation material is comprised of:
polyvinyl alcohol and derivatives thereof;
cellulosic derivative materials thereof;
porous polymeric discs or beads and not proximal to the electrode-separator assembly thereof, where the porous polymer discs or beads are comprised of PP, HDPE, UHMWPE, PVC, PVA, PVDF, PTFE, PES, PESO;
where the range of additive concentration applied per volumetric quantity of the battery cell electrolyte is 1 to 20 g/m̂2; or
combinations thereof.

10. A battery separator for a lead-acid battery comprising:
an additive configured to mitigate water loss and destructive processes within the lead-acid battery as a result of the water loss;
wherein the additive is included with the battery separator to address deleterious effects to critical battery performance features brought about by a sustained reduction in a battery electrolyte volume over a service life of the lead-acid battery.

11. The battery separator of claim 10, wherein the additive is configured to suppress a rate of water loss over the service life of the lead-acid battery resulting in a reduced level of electrolyte leading to dry-out, thus exposing battery component weld points, electrode plates and connections leading to accelerated corrosion, increasing an electrolyte acid concentration, a negative electrode sulfation and a positive electrode grid corrosion and an excessive outgassing of H2 and O2 gasses, whereby the consequences of water loss affect key battery performance features including an energy storage capacity, a cold cranking amperage, a hazardous gas venting, and a marked reduction in cycling or the service life.

12. The battery separator of claim 10, where the additive has a general formula of:
C_{(X)} H_{(Y)} O_{(Z)};
where X=8 to 18 carbon atoms;
where Y=1 to 38 hydrogen atoms; and
where Z=0 to 1 oxygen atoms.

13. The battery separator of claim 12 where the general formula of the additive is:
C_{(X)} H_{(Y)} O_{(Z)};
where X=12 to 16 carbon atoms;
where Y=26 to 34 hydrogen atoms; and
where Z=0 to 1 Oxygen atoms.

14. The battery separator of claim 13 where the general formula of the additive is:
C_{(X)} H_{(Y)} O_{(Z)};
where X=16 carbon atoms;
where Y=34 hydrogen atoms; and
where Z=0 to 1 oxygen atoms.

15. The battery separator of claim 12, where the general formula of the additive deployed in the lead-acid battery includes compounds that are fully saturated and may be straight chain, branched chain or cycloalkane and isomeric derivatives thereof, where the compounds of the additive are deployed neat or as mixtures with other additives thereof.

16. The battery separator of claim 10, wherein the additive included in the battery separator of the lead-acid battery:
is introduced into a separator manufacturing process of the battery separator during a polymer/filler extrusion operation either neat or as a mixture of pore forming agents, wherein the additive has suitable solubility characteristics in the extraction solvent of the separator manufacturing process thus rendering the additive recoverable upon distillation-separation and amenable to deposition in a concentration controlled manner upon internal and external surfaces of the separator;
comprises 0% to 100% of a pore forming agent concentration during the process of extrusion of the battery separator;
is added directly and in a controlled manner to the extraction solvent during the extraction process to affect controlled deposition of the additive onto the external and internal surfaces of the battery separator;
is applied to the finished battery separator in a controlled manner as a secondary manufacturing operation by means of spray, dip, immersion or other coating processes;
is applied in its neat form to the battery separator at the completion of the production process by means of metered dose spray application technologies; or
combinations thereof.

17. A method of mitigating water loss in a lead-acid battery comprising:
deploying an additive in the lead-acid battery configured to mitigate water loss and destructive processes within the lead-acid battery as a result of the water loss;
wherein the additive is deployed in the lead-acid battery to address deleterious effects to critical battery performance features brought about by a sustained reduction in battery electrolyte volume over a service life of the lead-acid battery.

18. The method of claim 17, wherein the additive deployed in the lead-acid battery is configured to suppress a rate of water loss over a service life of the lead-acid battery resulting in a reduced level of electrolyte leading to dry-out, thus exposing battery component weld points, electrode plates and connections leading to accelerated corrosion, increasing an electrolyte acid concentration, a negative electrode sulfation and a positive electrode grid corrosion and an excessive outgassing of H2 and O2 gasses, whereby the consequences of water loss affect key battery performance features including an energy storage capacity, a cold cranking amperage, a hazardous gas venting, and a marked reduction in cycling or service life,
where the additive deployed in the lead-acid battery has a general formula of:
C_{(X)} H_{(Y)} O_{(Z)};
where X=8 to 18 carbon atoms;
where Y=1 to 38 hydrogen atoms; and
where Z=0 to 1 oxygen atoms.

19. The method of claim 17, wherein deploying the additive in the lead-acid battery includes adding the additive with a battery separator of the lead-acid battery, wherein adding the additive with the battery separator including:
introducing the additive into a separator manufacturing process of the battery separator during a polymer/filler extrusion operation either neat or as a mixture of pore forming agents, wherein the additive has suitable solubility characteristics in the extraction solvent of the separator manufacturing process thus rendering the additive recoverable upon distillation-separation and amenable to deposition in a concentration controlled manner upon internal and external surfaces of the separator;
including 0% to 100% of a pore forming agent concentration during the process of extrusion of the battery separator;
adding the additive directly and in a controlled manner to the extraction solvent during the extraction process to affect controlled deposition of the additive onto the external and internal surfaces of the battery separator;
applying the additive to the finished battery separator in a controlled manner as a secondary manufacturing operation by means of spray, dip, immersion or other coating processes;
applying the additive in its neat form to the battery separator at the completion of the production process by means of metered dose spray application technologies; or
combinations thereof.

20. The method of claim 17, wherein deploying the additive in the lead-acid battery includes:
not including the additive with a battery separator of the lead-acid battery thereby mitigating any occlusion or partial blockage of a porosity of the battery separator thus reducing electrical resistance within the battery during initial battery formation steps thereby optimizing the time and energy resources of the battery manufacturer during the critical formation process thereby benefitting the lead-acid manufacturing process;
applying the additive directly on a positive electrode substrate or a negative electrode substrate utilized for bonding an active paste material to a lead grid electrode plate, thereby benefitting the lead-acid manufacturing process by providing a means to optimize the battery manufacture process through enhanced active material adhesion and enhanced plate cure energy resources;
including the additive in the lead-acid battery in such a way as to engage a diffusion rate limiting release of additive over the extended cycle life of the battery, wherein the range of additive concentration applied per unit area of active material substrate is 1 to 20 g/m̂2;
adding the additive on a fibrous adsorptive or non-adsorptive oxidation resistant laminate material proximal to a positive electrode or a negative electrode of the lead-acid battery thereby benefitting the lead-acid battery manufacturing process, where the inclusion of said laminates within the battery design is an economical approach to the enhancement of cycle life, whereby the range of additive concentration added per unit area of fibrous adsorptive or non-adsorptive oxidation resistant laminate is 1 to 20 g/m̂2;
applying the additive to an additive bearing material that is a fibrous adsorptive or non-adsorptive oxidation resistant material that is configured to be placed within a case and not proximal to the electrodes, wherein the fibrous adsorptive or non-adsorptive oxidation resistant materials with the additive applied are configured to be:
used as a liner material corresponding to the periphery of the sides and bottom of the battery containment case;
fixed in place by oxidation resistant adhesive materials;
within the battery case as a free moving material without constraint of fixture;
utilized in the injection molding process during battery containment case manufacture; or
utilized in the injection molding process during electrolyte anti-stratification mixing component manufacture;
whereby the range of additive concentration applied per unit area of the additive bearing material is 1 to 20 g/m̂2;
adding the additive as a bolus directly into the battery cell electrolyte during the battery manufacturing and forming process, where the range of additive concentration applied per volumetric quantity of cell electrolyte is 1 to 20 g/m̂2;
adding the additive as a time release module regulated by diffusion rate limiting encapsulation materials; where the time release encapsulation material is comprised of:
polyvinyl alcohol and derivatives thereof present in the current state of the art;
cellulosic derivative materials thereof present in the current state of the art;
porous polymeric discs or beads present in the current state of the art and not proximal to the electrode-separator assembly thereof, where the porous polymer discs or beads can be comprised of PP, HDPE, UHMWPE, PVC, PVA, PVDF, PTFE, PES, PESO;
where the range of additive concentration applied per volumetric quantity of cell electrolyte is 1 to 20 g/m̂2; or
combinations thereof.
